(19) United States
(12) Patent Application Publication
(10) Pub. No.: US 2002/0112444 A1
(43) Pub. Date: Aug. 22, 2002

(54) SEALED GARAGE DOOR JOINT WITH THERMAL BREAK

(76) Inventor: Francis Lacasse, St -Redempteur, CA (US)

Correspondence Address: David J. French, Box 2486, Stn." D", Ottawa, ON, K1P 5W6, CA

(21) Appl. No.: 09/784,310

(22) Filed: Feb. 16, 2001

(51) Int. Cl. E06B 7/22

(52) U.S. Cl. 52/784.13; 52/784.16; 52/800.1; 52/802.1; 52/716.8

(57) ABSTRACT

A joining strip is provided by which sheet metal may be formed into a hollow tubular panel. The joining strip provides a seam between panel edges that acts as a thermal break between inner and outer faces of the panel. The joining strip may also carry a resilient tubular cushion which extends into the joint between the side ends of two panels that are connected by a hinge. This cushion contributes to providing an air seal within the joint between the two panels. Applications include roll-up garage doors and roll-away, articulated walls.

### FIELD OF THE INVENTION

This invention relates to sheet metal panels that are provided with a thermal break. It also relates to doors made from a series of such panels joined by hinged couplings to serve in a garage door or the like. In particular the invention relates to a method of sealing such joints to minimize the passage of air there through.

### BACKGROUND TO THE INVENTION

Various technologies have been applied in the past to the joining of sheet metal panels to form doors having inner and outer faces. Further, such panels have been assembled with a series of hinged joints to provide a roll-up door. A particular application of this technology has been in the fabrication of garage doors.

It is useful to provide a thermal break between the pieces of sheet metal forming the inner and outer surfaces of a barrier such as a door. Particularly when the sheet metal is aluminum or steel, thermal conduction from an outer panel exposed to low temperatures can lead to the cooling of the inner panel with resulting condensation. Such condensation can eventually cause corrosion and damage to the door and its parts.

It is therefore one object of this invention to provide a means for joining two panels together that provides a thermal break for such panels.

It has been known to provide special shapes for adjoining edges of panels which are hinged to each other in order to minimize the risk that an object, e.g. a finger, may be pinched in the joint when the joint closes. Such edges are often provided with shapes of complementary curvature that permit the panels to be either aligned into a planar format, or oriented at an angle with respect to each other. Typically, one edge is generally of a convex, somewhat parabolic shape, while the other edge is concave with a complementary curvature. This minimizes the amount of gap that is formed when the joint opens.

The present invention incorporates into such a joint a sealing feature which minimizes the loss of air which might otherwise flow through the joint.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, in each of the individual claims which conclude this Specification.

### SUMMARY OF THE INVENTION

In one broad aspect, the invention is a flexible joining strip preferably of resilient polymeric material providing two parallel slots to receive edges from respective inner and outer portions of a modular panel that is to form part of a roll-up door or wall. These panel portions are of a sheet material, preferably sheet metal. A central web separating the two slots provides the joining strip with a partially “M”-shaped cross-section. The central web extends below the base of the “M” to terminate in an inverted “T”-shaped flange with outwardly-extending lateral portions. The respective lateral portions of the “T” extend across the direct, aligned path of entry into the respective slots. The flange on the central web is, however, displaced sufficiently below the base of the “M” to provide an access path for entry of sheet edges into the respective slots.

The material of the joining strip has a thermal conductivity which is less than that of a metal. Thus, when serving to bind the seam between two metal sheets, the joining strip will provide a thermal break. The sealing strips may be fitted to the edges of the panel portions by sliding such strips onto the edges endwise. Alternatively, by forming the joining strip from material of a flexible nature, particularly when warmed, the outer sides of the slot may be flexed to admit the entry of the edges of the sheet material into the respective slots. Those edges may be bent or of a “hooked” shape in cross-section to fit into the slots. The flange is positioned to block the direct removal of the preferably hooked edges from the slots. This provides a stable coupling between the two edges of the sheet material panel portions.

When a panel is to be formed by joining two separate metal panel portions together, the paired edges along the top and bottom of both of the inner and outer sheet metal panel portions may be joined along their longitudinal edges to provide an inner, enclosed volume. Alternately, a single sheet of metal can be bent to provide both the inner and the outer faces of the panel. In this latter case only a single pair of edges need be joined by the joining strip to provide a single seam. While this arrangement is an option, a disadvantage of this arrangement is that the sheet metal along one edge of the panel is continuous, without a thermal break being present. For maximum thermal isolation, panels should be formed with separate inner and outer sheet metal portions, joined by two, upper and lower seams. Further and preferably, such two piece panel portions are symmetrical when assembled, allowing such parts to be produced from a single production die. Also preferably, the interior volume of each panel is filled with a stiffening insulation material such as polyurethane foam.

As a preferred feature, the outer face of the flange portion of the web on the joining strip carries a hollow, flexible tubular cylinder which can be compressed into a flattened position adjacent to the flange to provide a sealing member. Preferably this tubular cylinder is made of a resilient material. When panels are assembled into an articulated door or wall, at least one seam should be equipped to provide a sealing member along a joining strip. Preferably two seams from adjacent panel longitudinal sides or ends may be provided with sealing members that contact each other and provide an improved airtight seal for a door when closed. By use of compliant material for the sealing member, the sealing member may be compressed within the space between adjoining seams of two door panels when the panels are brought into planar adjustment. It is not, however, necessary, for both joining strips to carry sealing members. It is sufficient for one joining strip to provide the necessary seal.

To allow panels to be assembled into an articulated wall or door having pinch-resisting joints, one of the longitudinal ends of each panel is preferably shaped to be generally convex, while the other longitudinal end is generally concave. The precise shape of these ends is selected to provide a close but not obstructing fit between the respective ends when one panel is rotated about a hinged axis with respect to the other panel. In the course of this rotation a portion of the joining strip, or sealing member if present, positioned along the seam formed on either the concave or the convex end of one panel may brush against the inner surface of the end of the other panel. This contact provides a barrier to entry of objects into the joint. Contact as described is permissible, however, only to the extent that motion between the two parts is not obstructed.

In this manner a joint is provided which provides a minimal gap that may pinch a person's fingers, acts as a thermal break between the inner and outer sheet metal portions of each panel, and further serves to create an airflow-resisting seal along the joints between panels when the panels are flattened out into a planar orientation with respect to each other.

The foregoing has provided a description of the invention and some of its optional aspects. The invention may be further understood by the description of the preferred embodiments, in conjunction with the drawings, which now follow.

### SUMMARY OF THE FIGURES

FIG. 1 is a schematic perspective view of a cross-sectioned sealing strip of the invention with the edge of a sheet metal panel positioned adjacent thereto, prior to being inserted into the sealing strip.

FIG. 2 is an end view of a garage door in perspective showing sheet metal hinged panels joined by sealing strips as in FIG. 1.

FIG. 2A is an enlarged end view detail of the joint between two sheet metal panels as in FIG. 2.

FIG. 2B is an enlarged end view detail of the bottom edge of the bottom panel of the door of FIG. 2.

FIG. 3 is a progressive series of detailed end views of the closing action of the joint between adjacent panel edges of the door of FIG. 2.

### DESCRIPTION OF THE PREFERRED EMBODIMENT

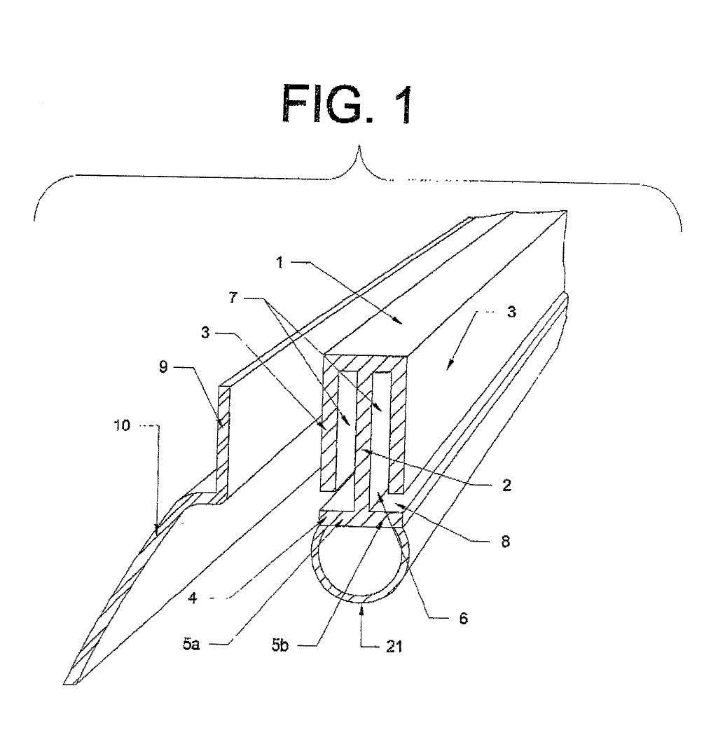

In FIG. 1 a sealing strip 1 has a central web 2 and two outer strips 3 that, along with web 2, provide an “M”-shaped cross-section.

The web 2 extends below the “M” to terminate in a flange 4, being of an inverted “T” shape in cross-section. The flange 4 has two laterally extending flange portions 5a, 5b.

The flange portions 5a 5b extend across the path 6 for direct entry into slots 7 present within the “M”. The flange portions 5a, 5b are also displaced from the base of the “M” to provide an access path 8 for metal edges 9 on a sheet metal panel portion 10 to extend outwards from the slots 7.

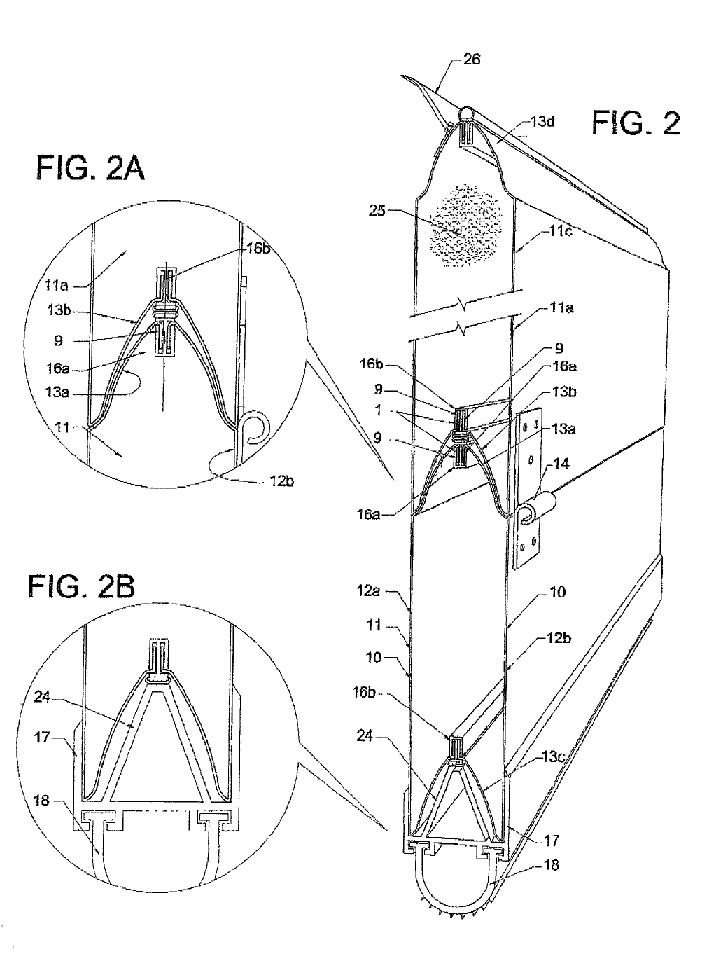

The sheet metal panel portion 10 is part of a sheet metal panel 11 shown in FIG. 2 composed of two panel portions 10 and having inner 12a and outer 12b faces and upper 13a and lower 13b longitudinal panel side or end boundaries. Conveniently, these panel portions 10 are symmetrical when assembled, allowing a single style of part to be used for either face 12a,12b of a panel 11. As shown in FIG. 2 the upper panel end 13a is preferably convex and the lower end 13b is concave.

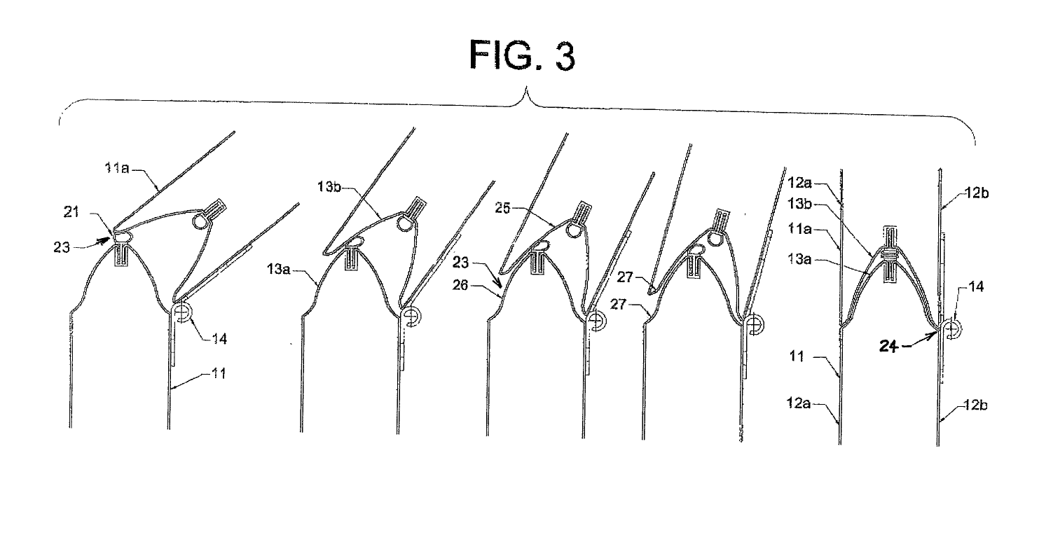

The shape of the respective panel ends 13a, 13b are such as to provide a non-obstructing rotation of one panel 11 with respect to an adjacent panel 11a about a laterally mounted hinge 14. This is shown in detail in FIG. 3. This shape also minimizes the presence of a gap 23 wherein a person's fingers may become pinched.

The joining of the inner 12a and outer 12b panel faces is effected along seams 16a, 16b within the ends 13a, 13b. A sealing strip 1 present at each seam 16a, 16b receives edge portions 9 from each of the panel faces 12a, 12b. This is shown in detail in FIG. 2A.

In FIG. 2 both the top 13a and bottom 13b panel ends have seams 16a, 16b. One sheet of metal could, however, be bent to form a panel 11 with a single seam. The interior volume of each panel 11 is preferably filled with an insulating and structural stiffening material such as polyurethane foam 25. This is shown pictorially in the top panel 11c of FIG. 2 by the field of dots.

The panels 11 are modular to permit assembly into a roll-up door or the like. The panel end 13c of the bottom panel 11 may receive a capping member 17 that fits over the end 13c. The bottom of the capping member 17 is preferably fitted with a resilient semi-circular strip 18 to serve as a bumper or edge protector when the door approaches the floor. The capping member 17 may also optionally include a sealing strut 24 extending to the seam 16b.

At the top of the door, a resilient strip 26 may seal the top end 13d of the door against a frame when the door is closed.

The sealing strip 21 fitted along the bottom face of the flange 4 on each sealing members 21 is dimensioned and positioned to create a seal with an adjacent panel end 13a, 13b when the panels 11 are in a coplanar orientation i.e., when the door is closed. Such sealing members 21 may be present on one or both of the seams 16a,16b of abutting panels 11. As well as providing a seal, the sealing members 21 can act as a cushion and reduce noise arising from opening or closing of the door.

In FIGS. 2 and 2A two strips 1 on adjacent panels 11a,11b virtually abut with each other when the panels 11a,11b are in a planar orientation to each other. This deforms the sealing members 21 due to their intimate contact with each other, providing an air seal. While shown as a tubular, resilient, partial cylindrical member in FIG. 1, this sealing member 21 may also be in the form of resilient strips (not shown), e.g. the cylindrical member may be slit longitudinally. The object is simply that the sealing member 21 will serve as a seal.

The sealing effect with cylindrical sealing members 21 is shown progressively in FIG. 3 where the stages of closing a garage door are depicted. Panels 11a, 11b rotate about hinge 14 towards closing. The edges 13a, 13b are shaped to minimize the risk of pinching an object in the closing gap 23 between the edges 13a, 13b. The sealing strip 1 with sealing member 21 on the convex end 13a just brushes against the surface of the concave end 13b as closing proceeds. When the sealing members 21 on the strips contact each other, they deform and flatten to provide the seal and cushioning effect.

The hinge 14 is preferably positioned on the panel face surface 12b of each panel 11, at the point 24 where ends 13a, 13b meet. With the hinge 14 at this location 24 surface points 25 on the moving panel edge 13b follow a circular trajectory about the hinge axis. The remote portion 26 of end 13a, removed from the hinge 14, may also be curved in a similar circular path. In this manner, the gap 23 is minimized for a substantial portion of the closing action.

An inflection zone 27 in the end faces 13a, 13b near the outer face portions 12a of each panel portion 10, located opposite to the hinge 14, can be shaped to close the gap 23 when the door is closed. At this inflection zone 27, the ends 13a, 13b may come fully into contact presenting a closed surface on the face of the door opposite to the hinge.

Conclusion

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure.

The embodiments of the invention in which an exclusive property or privilege is claimed are defined as follows:

1. A flexible joining strip for joining two sheeting edges, said strip being provided with two parallel slots to receive such edges, said strip having a central web separating the two slots to provide the joining strip with a partially “M” shape in cross-section, the central web extending below the base of the “M” to terminate in a cross-sectionally inverted “T”-shaped flange with outwardly extending lateral portions, the respective lateral portions of the flange extending across the direct, aligned path of entry into the respective slots to block direct removal from said slot of an edge fitted into said slot, the lateral portions of the flange on the central web being displaced sufficientlcy below the base of the “M” to provide an access path for said edges to extend into the respective slots.

2. A strip as in claim 1 wherein the material of the joining strip has a thermal conductivity which is less than that of a metal.

3. The strip of claim 1 in combination with a panel having two inner and outer panel portions of sheet material, each panel portion respectively having a longitudinal edge extending along at least one end boundary of such panel wherein said longitudinal panel portion edges are coupled together by being respectively inserted into said respective slots to provide a seam between said panel portions.

4. A strip as in claim 1 in combination with a single sheet of metal having two longitudinal edges and bent to provide both the inner and the outer faces of a panel wherein the longitudinal edges are joined by the joining strip along a seam to provide an inner enclosed volume.

5. The strip of claim 3 wherein said panel portions are separate panel portions, each panel portion having longitudinal edges extending along both top and bottom end boundaries of the panel, and wherein the longitudinal edges at the top and bottom end boundaries of the panel are joined respectively by a joining strip.

6. A strip as in claim 1 comprising a sealing member extending along the outer face of the flange, remote from the central web.

7. A strip as in claim 6 wherein said sealing member comprises a hollow, flexible tubular cylinder which can be compressed into a flattened condition adjacent to the flange.

8. A strip as in claim 7 wherein the sealing member is made of a resilient material.

9. A strip as in claim 1 in combination with adjacent panels forming an articulated door or wall, said panels being joined by hinge means each with a hinge axis, said panels each comprising sheet panel-portions bent to provide at least one set of adjoining longitudinal edges for such panel wherein said edges are held together by insertion of the edges into the slots in said joining strip to form a seam.

10. A strip as in claim 9 wherein the panels each comprise two panel portions, each panel portion comprising two longitudinal edges, wherein said edges are joined in pairs with said joining strips to form seams along respective longitudinal ends of each panel and to define an inner enclosed volume.

11. A strip as in claim 9 wherein said panels comprise two opposed longitudinal ends one of which longitudinal ends is shaped to be generally convex, while the other longitudinal end is generally concave to provide a close but not obstructing fit between the respective ends when one panel is rotated about the hinge axis with respect to the other panel.

12. A strip as in claim 11 wherein a portion of the joining strip along the seam formed on the convex end of one panel brushes against the inner surface of the concave end of the other panel when one panel is rotated about the hinge axis with respect to the other panel.

13. A strip as in claim 10 wherein each said joining strip each bears against another joint strip when the panels are flattened out into a planar orientation with respect to each other.

14. A strip as in claim 9 comprising a joining strip which carries a sealing member that bears against the longitudinal end of an adjacent panel when the panels are flattened out into a planar orientation with respect to each other.

15. A strip as in claim 9 wherein each panel has two longitudinal ends and further comprising a sealing member mounted along the flange of a joining strip lying along the seam on the longitudinal end of one of the two adjacent hinged panels, said sealing member being positioned to bear against the end of the adjacent panel when the panels are flattened out into a planar orientation with respect to each other.

16. A strip as in claim 10 wherein said joining strips each carrying a sealing member that respectively bears against an adjacent sealing member when the panels are flattened out into a planar orientation with respect to each other.

17. A strip as in claim 11 wherein the hinge axis is located proximate to one corner of the abutting ends of adjacent panels and portions of the longitudinal ends of the hinged panels rotating about such axis are concentrically curved about such axis to minimize the gap formed when adjacent panels are bent out of planar alignment with each other.

18. A strip as in claim 17 wherein the panel ends remote from the hinge axis have an inflection zone whereat such ends meet when the panels are flattened out into a planar orientation with respect to each other.
